(19) United States
(12) Patent Application Publication
(10) Pub. No.: US 2021/0221328 A1
(43) Pub. Date: Jul. 22, 2021

(54) Vehicle Occupant Reminder System

(71) Applicant: Amy Naeem, Rocky River, OH (US)

(72) Inventor: Amy Naeem, Rocky River, OH (US)

(21) Appl. No.: 16/886,250

(22) Filed: May 28, 2020

Related U.S. Application Data
(60) Provisional application No. 62/964,195, filed on Jan. 22, 2020.

(51) Int. Cl. B60R 25/102; B60R 25/40; B60N 2/00; B60R 25/31; B60R 25/32

(52) U.S. Cl. CPC B60R 25/102; B60R 25/403; B60R 25/32; B60R 25/31; B60N 2/002

(57) ABSTRACT

A vehicle occupant reminder system is shown and described. The vehicle occupant reminder system includes a first sensor. The first sensor is placed in a child car seat. The first sensor will determine if there is an occupant in the vehicle. A second sensor will determine if the vehicle is in an activated state. The first sensor and the second sensor are connected to a CPU. The CPU will take inputs from the first sensor and the second sensor. The CPU will send a warning via a wireless transceiver upon determining that there is an occupant in a vehicle that is off.

### CROSS REFERENCE TO RELATED APPLICATIONS

This application claims the benefit of U.S. Provisional Application No. 62/964,195 filed on Jan. 22, 2020. The above identified patent application is herein incorporated by reference in its entirety to provide continuity of disclosure.

### BACKGROUND OF THE INVENTION

The present invention relates to a vehicle occupant reminder system. More particularly, the present invention provides a system that will detect if an occupant is in a vehicle and determine if the engine of the vehicle is running.

Many individuals take children with them on errands or the like. Even the most perfect parents using extreme care can be forgetful. This means that some such individuals may forget their child, leaving them in the vehicle accidentally. The same may be true for pets or other living things. This may be disastrous.

Depending on the time of year, internal vehicle temperatures can range between extreme cold and extreme heat, both of which are dangerous to a vehicle occupant over an extended period of time. Without a method of notification, an individual may not realize that the child or pet was left in the vehicle for a length of time.

Consequently, there is a need for an improvement in the art of vehicle occupant reminders. The present invention substantially diverges in design elements from the known art while at the same time solves a problem many people face when entering and leaving a vehicle. In this regard the present invention substantially fulfills these needs.

### SUMMARY OF THE INVENTION

The present invention provides a vehicle occupant reminder system wherein the same can be utilized for providing convenience for the user when using a vehicle occupant reminder system. The vehicle occupant reminder system is comprised of a first sensor located within a mat. The first sensor will determine occupancy of the vehicle. A second sensor will determine if the vehicle is turned on. The first sensor and the second sensor are connected to a CPU. The CPU is further connected to a wireless transceiver.

Another object of the vehicle occupant reminder is to provide a car seat that has the first sensor integrated into the seat.

Another object of the vehicle occupant reminder is to provide a power source that is connected to the first sensor and the second sensor. In one instance the power source is the vehicle battery.

Another object of the vehicle occupant reminder is to provide a pressure sensor as the first sensor.

Another object of the vehicle occupant reminder is to provide a vibration sensor as the second sensor.

Another object of the vehicle occupant reminder is to provide a logic stored within the CPU. The logic will use an input from the first sensor and the second sensor to determine if there is an occupant in a vehicle that is in the off status.

Another object of the vehicle occupant reminder is to provide a CPU logic that will send a warning via the wireless transceiver when there is an occupant in the vehicle that is in the off status.

Another object of the vehicle occupant reminder is to provide a fob connected to the CPU via the wireless transceiver. The fob will receive warnings of improper vehicle occupancy in potentially unsafe conditions.

Another object of the vehicle occupant reminder is to provide that the wireless transceiver is connected to a mobile device.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the vehicle occupant reminder system with a sensor placed in a car seat.

FIG. 2 shows a perspective view of an embodiment of the vehicle occupant reminder system with a sensor integrated into a car seat.

FIG. 3 shows a wiring diagram of an embodiment of the vehicle occupant reminder system.

FIG. 4 shows a flow chart of an embodiment of the operation of the vehicle occupant reminder system.

### LIST OF REFERENCE NUMERALS

With regard to the reference numerals used, the following numbering is used throughout the drawings.
101 First sensor
102 Sensor mat
103 child car seat
103A Car seat frame
103B Car seat padding
301 Power source
302 Second sensor
303 CPU
304 Wireless transceiver
305 key fob
305A Speaker
306 Mobile device
306A Speaker
401-408 Method Steps

### DETAILED DESCRIPTION OF THE INVENTION

Reference is made herein to the attached drawings. Like reference numerals are used throughout the drawings to depict like or similar elements of the vehicle occupant reminder system. For the purposes of presenting a brief and clear description of the present invention, a preferred embodiment will be discussed as used for the vehicle occupant reminder system. The figures are intended for representative purposes only and should not be considered to be limiting in any respect.

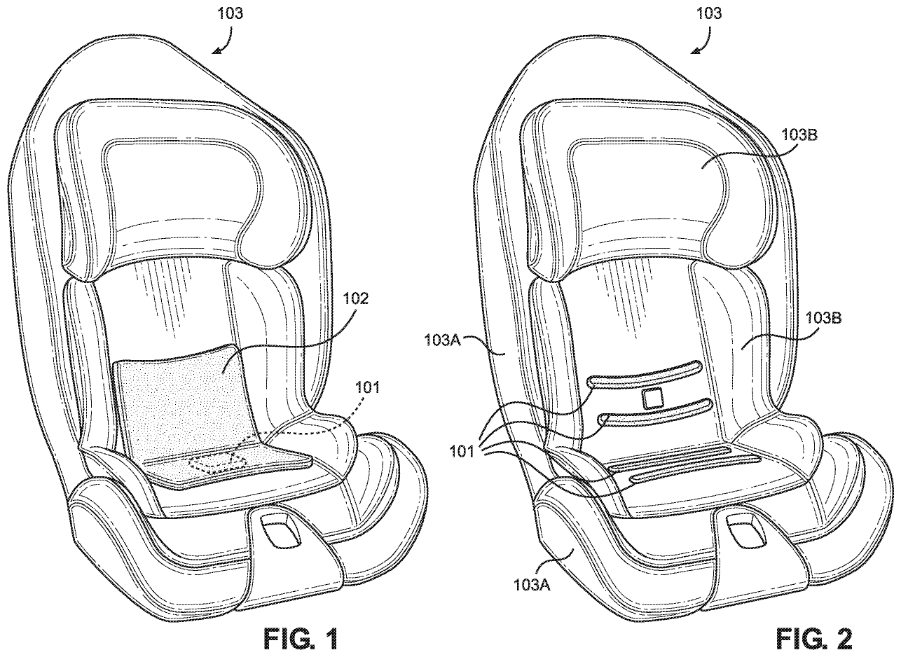

Referring now to FIG. 1, there is shown a perspective view of an embodiment of the vehicle occupant reminder system with a sensor placed in a car seat. The vehicle occupant reminder system includes a first sensor 101. The first sensor 101 is located within the cabin of a vehicle. The first sensor 101 will determine if there is an occupant in the vehicle. In one embodiment, the first sensor 101 is a pressure sensor.

In one embodiment, the first sensor 101 is incorporated into a mat 102. The mat 102 is capable of being placed within a vehicle. In one embodiment, the mat 102 doubles as a protective seat covering. In another embodiment, the mat 102 has a padding located therein. In the shown embodiment, the mat 102 is placed on a child's car seat 103. This will allow the first sensor 101 to determine if there is a child placed in the car seat 103.

Referring now to FIG. 2, there is shown a perspective view of an embodiment of the vehicle occupant reminder system with a sensor integrated into a car seat. In this embodiment, the first sensor 101 is integrated into a child's car seat 103. In one embodiment, the first sensor 101 is integrated into a frame 103A of the car seat 103. In another embodiment the first sensor 101 is integrated into a padding 103B of the car seat 103. In one embodiment there are several first sensors 101 placed within the car seat 103. In the shown embodiment there are first sensors 101 on the seat portion and additional first sensors 101 on a back portion. This will allow for redundancies in case of a first sensor failure or if the occupant is leaning away from a first sensor that may not register the weight. When a child is placed within the car seat 103, the first sensor 101 will register that there is an occupant within the vehicle.

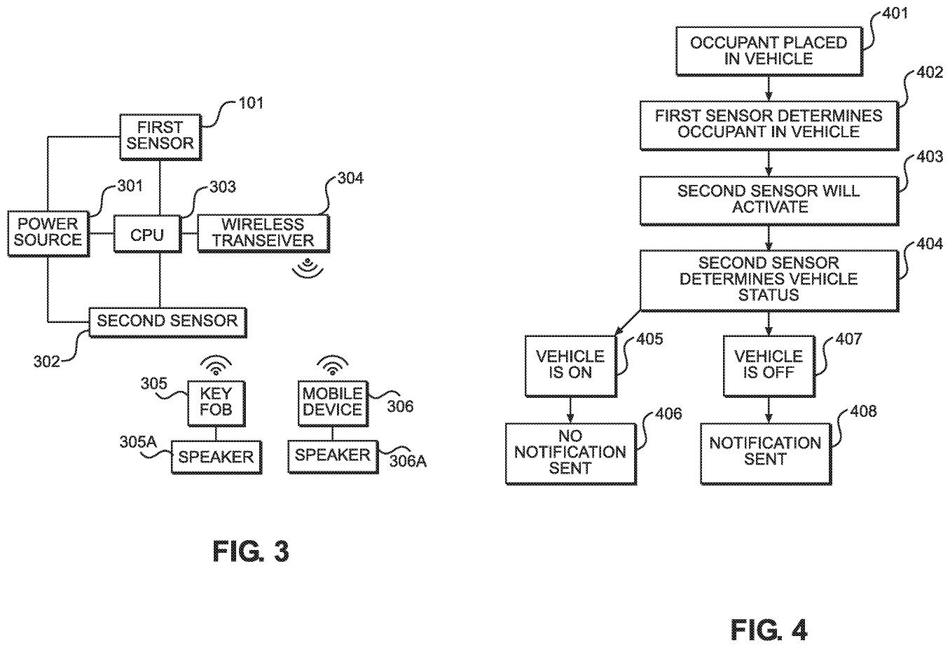

Referring now to FIG. 3, there is shown a wiring diagram of an embodiment of the vehicle occupant reminder system. The vehicle occupant reminder system includes a first sensor 101 as described above. The first sensor 101 is connected to a power source 301. In one embodiment, the power source 301 is the vehicle battery. In another embodiment, the power source 301 is a separate power source from the vehicle. There is a second sensor 302 coupled to the power source 301. In one embodiment, second sensor 302 is located within the engine bay of the vehicle. The second sensor 302 will determine if the engine is running. In one embodiment, the second sensor 302 is vibration sensor.

The first sensor 101 and the second sensor 302 are further coupled to a CPU 303. The CPU 303 is coupled to the power source 301. The CPU 303 will take in sensor input from the first and second sensors 101, 302 and use a logic to make determinations. These determinations will determine if the vehicle is running and if an occupant is in the vehicle as described in FIG. 4. The CPU 303 is coupled to a wireless transceiver 304. The wireless transceiver 304 will transmit signals to designated devices.

In on embodiment, the wireless transceiver 304 is connected to a fob 305. In one embodiment, the fob 305 includes a speaker 305A. The wireless transceiver 304 will transmit signals to the fob 305 to alert a person that there is an occupant in the vehicle. In another embodiment, the wireless transceiver 304 is connected to a mobile device 306. In one embodiment, the mobile device 306 includes a speaker 306A. The wireless transceiver 304 will transmit signals to the mobile device 306 to alert a person that there is an occupant in the vehicle.

Referring now to FIG. 4, there is shown a flow chart of an embodiment of the operation of the vehicle occupant reminder system. One embodiment of a use case for the vehicle occupant reminder system includes placing a child within a seat having a first sensor 401. The first sensor will determine that there is on occupant in the vehicle 402. The second sensor will then activate 403. The second sensor will determine the status of the vehicle 404. In one embodiment, the second sensor will determine that the vehicle is in an activated state 405. In this state the vehicle will be running and the engine will be activated. In this embodiment no notification will be sent 406. The second sensor will continue to determine vehicle status 404.

In another embodiment, the second sensor will determine that the vehicle is in a deactivated state 407. In this state the vehicle will be off and the engine will not be running. In this case a warning notification will be sent 408. In one embodiment, the warning notification will be sent to the fob. In another embodiment, the warning notification will be sent to the mobile device. In yet another embodiment, the warning will be sent to a combination of devices. In other embodiments, multiple notifications may be sent at different times. In one embodiment the warning notification is an audible alarm produced by the speaker.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle occupant reminder system, the system comprising:
a first sensor located within a mat, wherein the first sensor determines vehicle occupancy;
a second sensor, wherein the second determines vehicle activation status;
the first sensor and the second sensor are connected to a CPU;
the CPU is secured to a wireless transceiver.

2) The vehicle occupant reminder system of claim 1, further comprising a power source connected to the first sensor and the second sensor.

3) The vehicle occupant reminder system of claim 2, wherein the power source is a car battery.

4) The vehicle occupant reminder system of claim 1, wherein the first sensor is a pressure sensor.

5) The vehicle occupant reminder system of claim 1, wherein the second sensor is a vibration sensor.

6) The vehicle occupant reminder system of claim 1, wherein the CPU contains a logic that will use an input from the first sensor and the second sensor to determine if there is an occupant in a vehicle that is in the deactivated state.

7) The vehicle occupant reminder system of claim 6, wherein the CPU logic will send a warning via the wireless transceiver when there is an occupant in the vehicle that is in the off status.

8) The vehicle occupant reminder system of claim 1, further comprising a fob connected to the CPU via the wireless transceiver.

9) The vehicle occupant reminder system of claim 8, wherein the CPU contains a logic that will use an input from the first sensor and the second sensor to determine if there is an occupant in a vehicle that is in the off status; and
wherein the CPU logic will send a warning to the fob via the wireless transceiver when there is an occupant in the vehicle that is in the off status.

10) The vehicle occupant reminder system of claim 1, wherein the wireless transceiver is connected to a mobile device.

11) A vehicle occupant reminder system, the system comprising:
a first sensor integrated into a car seat, wherein the first sensor determines vehicle occupancy;
a second sensor, wherein the second determines vehicle activation status;
the first sensor and the second sensor are connected to a CPU;
the CPU is secured to a wireless transceiver.

12) The vehicle occupant reminder system of claim 11, further comprising a power source connected to the first sensor and the second sensor.

13) The vehicle occupant reminder system of claim 12, wherein the power source is a car battery.

14) The vehicle occupant reminder system of claim 11, wherein the first sensor is a pressure sensor.

15) The vehicle occupant reminder system of claim 11, wherein the second sensor is a vibration sensor.

16) The vehicle occupant reminder system of claim 11, wherein the CPU contains a logic that will use an input from the first sensor and the second sensor to determine if there is an occupant in a vehicle that is in the off status.

17) The vehicle occupant reminder system of claim 16, wherein the CPU logic will send a warning via the wireless transceiver when there is an occupant in the vehicle that is in the off status.

18) The vehicle occupant reminder system of claim 11, further comprising a fob connected to the CPU via the wireless transceiver.

19) The vehicle occupant reminder system of claim 18, wherein the CPU contains a logic that will use an input from the first sensor and the second sensor to determine if there is an occupant in a vehicle that is in the off status; and
wherein the CPU logic will send a warning to the fob via the wireless transceiver when there is an occupant in the vehicle that is in the off status.

20) The vehicle occupant reminder system of claim 1, wherein the wireless transceiver is connected to a mobile device.
